(19) United States
(12) Patent Application Publication
(10) Pub. No.: US 2018/0281362 A1
(43) Pub. Date: Oct. 4, 2018

(54) DECORATIVE PANEL

(71) Applicant: TOYODA GOSEI CO., LTD., Kiyosu-shi (JP)

(72) Inventors: Sadanori ANDO, Kiyosu-shi (JP); Chiharu TOTANI, Kiyosu-shi (JP); Tatsuo ITO, Kiyosu-shi (JP); Hiroshi IWATA, Kiyosu-shi (JP)

(21) Appl. No.: 15/867,790

(22) Filed: Jan. 11, 2018

(30) Foreign Application Priority Data
Mar. 29, 2017 (JP) 2017-065513

(51) Int. Cl. B32B 27/08

(52) U.S. Cl. CPC B32B 27/08; B32B 2307/418; B32B 2605/003; B32B 2255/00; B32B 2451/00; B32B 2307/412

(57) ABSTRACT

To provide a decorative panel that expresses a deep jet-black color represented by Japanese lacquer or the like. Provided are: a base member; a black-colored layer provided on the base member; and a laminate provided on the black-colored layer, the laminate having a plurality of transparent layers having different refractive indexes such that the plurality of transparent layers are layered. The refractive indexes of the transparent layers in the laminate are increased in order toward the base member.

### TECHNICAL FIELD

The present invention relates to a decorative panel.

### BACKGROUND ART

Conventionally, for interior components for vehicles, such products are designed to have a lustrous black color called a jet-black color in order to provide the products with, for example, a sense of luxury.

As a method for creating a surface of a molded product so as to have a jet-black color, a method in which the surface of the molded product is coated by using black ink containing black pigment, the black ink is dried to forma black ink layer, and, further, clear coating is performed on the black ink layer so as to provide luster, is known. Furthermore, as an alternative coating method, a method in which a black color decoration film formed by a surface of a transparent film being black-coated is used and the black color decoration film is integrated with a molded product such that the transparent film side is the front side, is also used.

In general, a Japanese lacquer material which typifies a material having a jet-black color allows an observer to feel a sense of luxury. A major factor in a sense of luxury provided by a Japanese lacquer material is considered to be “feeling of depth” that is visually perceived. A technique that focuses on the “feeling of depth” is disclosed in, for example, Japanese Laid-Open Patent Publication No. 2010-36138. In Japanese Laid-Open Patent Publication No. 2010-36138, a thin film structure is disclosed. In the thin film structure, a fine-particles-containing thin film layer that contains fine particles and a binder resin, and a clear coat layer that is a colorless or colored transparent thin film layer are layered over a base member. In the thin film structure disclosed in Japanese Laid-Open Patent Publication No. 2010-36138, fine particles and the binder resin having different refractive indexes, respectively, are contained in the fine-particles-containing thin film layer, whereby light is refracted in the thin film structure in a complex manner, and the “feeling of depth” is thus generated.

However, although the thin film structure disclosed in Japanese Laid-Open Patent Publication No. 2010-36138 represents the “feeling of depth” to some degree, and allows an observer to feel a sense of luxury, a deep jet-black color provided by Japanese lacquer or the like has not yet been expressed.

### SUMMARY OF INVENTION

### Technical Problem

The present invention has been made in view of the aforementioned circumstances, and an object of the present invention is to provide a decorative panel that expresses a deep jet-black color represented by Japanese lacquer or the like.

### Solution to Problem

The inventors of the present invention have performed thorough investigation for obtaining a decorative panel that expresses a jet-black color representing more profound “feeling of depth”, in order to attain the aforementioned object. As a result, the inventors of the present invention have found that, when a laminate having a plurality of transparent layers provided on a black-colored layer is structured such that refractive indexes of the transparent layers are increased in order starting from the outermost side toward a base member, a jet-black color representing more profound “feeling of depth” is expressed.

That is, the present invention is made on the basis of the above-described findings, and a decorative panel of the present invention includes: a base member; a black-colored layer provided on the base member; and a laminate provided on the black-colored layer, the laminate having a plurality of transparent layers having different refractive indexes such that the plurality of transparent layers are layered. The refractive indexes of the transparent layers in the laminate are increased in order toward the base member.

### Advantageous Effects of Invention

In the configuration of the present invention, a person who sees the decorative panel according to the present invention is allowed to effectively perceive a jet-black color representing profound “feeling of depth” provided by Japanese lacquer or the like.

### BRIEF DESCRIPTION OF DRAWINGS

FIG. 1 schematically illustrates a cross-section of a decorative panel according to example 1 (experimental example 1);

FIG. 2 schematically illustrates a cross-section of a decorative panel according to example 2 (experimental example 2);

FIG. 3 schematically illustrates a cross-section of a decorative panel according to comparative example 1 (experimental example 3);

FIG. 4 schematically illustrates a cross-section of a decorative panel according to comparative example 2 (experimental example 4); and

FIG. 5 illustrates a decorative panel according to an embodiment.

### DESCRIPTION OF EMBODIMENTS

A preferred embodiment of a decorative panel according to the present invention will be described below.

An embodiment of the present invention will be described as a particularly useful mode in which the present invention is carried out, and the present invention is not limited to the embodiment. Furthermore, matters which are other than matters specifically described herein and which are necessary for carrying out the preset invention are understood as design matters, for a person skilled in the art, based on conventional arts in the relevant field. The present invention is carried out on the basis of the contents disclosed herein and common technical knowledge in the relevant field.

A decorative panel according to the present embodiment includes a base member, a black-colored layer provided at the base member, and a laminate provided at the black-colored layer.

The base member is a molded product used for an on-vehicle interior component such as an instrument panel or a dashboad. Examples of a material of the base member include synthetic polymers such as methyl methacrylate (co)polymers, polycarbonate, styrene (co)polymers, and methyl methacrylate-styrene copolymers, semi-synthetic polymers such as cellulose diacetate, cellulose triacetate, and cellulose acetate butyrate, polyester such as polyethylene terephthalate and polylactic acid, polyamide, polyimide, polyethersulfone, polysulfone, polyethylene, polypropylene, polymethylpentene, polyvinyl chloride, polyvinyl acetal, polyether ketone, polyurethane, and composites of these polymers (composite of polymethyl methacrylate and polylactic acid, composite of polymethyl methacrylate and polyvinyl chloride, and the like). Furthermore, the material of the base member may be a metal.

The black-colored layer is provided on the surface of the base member. In the decorative panel of the present embodiment, the laminate having the black-colored layer disposed at a portion, of the laminate, closest to the base member, and the base member are integrally formed, and the black-colored layer is thus provided on the surface of the base member. The black-colored layer is formed by the surface of the laminate being coated with ink (hereinafter, referred to as black ink) having black coloring matter. As the black ink, a commercially available black ink may be used, and the black-colored layer is formed on the surface of the laminate in an appropriate method. Examples of the method include printing methods such as a screen printing method, a gravure printing method, a flexographic printing method, an offset printing method, and a letterpress printing method.

Furthermore, the black-colored layer is any layer that is visually recognized as being black-colored. In the black-colored layer, for example, the L* value that is defined in the L*a*b* color system specified in JIS Z 8729, preferably has a smaller value. Specifically, the L* value is preferably not greater than 27 in the SCI mode.

The laminate is formed by a plurality of transparent layers being layered. The “transparent” of the transparent layer indicates that the total light transmittance is not less than 80%, preferably not less than 85%, and more preferably not less than 90%. The total light transmittance is measured in compliance with JIS K7361.

The inventors of the present invention have performed thorough investigation for determining how profoundly the decorative panel expresses a jet-black color representing the “feeling of depth” when the laminate that includes a plurality of transparent layers is disposed on the black-colored layer provided on the surface of the base member, and the inventors of the present invention have focused on refractive indexes of the respective transparent layers forming the laminate. The inventors of the present invention have found that, when the transparent layers are layered in the laminate such that refractive indexes of the respective transparent layers are increased in order toward the base member, the decorative panel having the laminate expresses a jet-black color representing more profound “feeling of depth”.

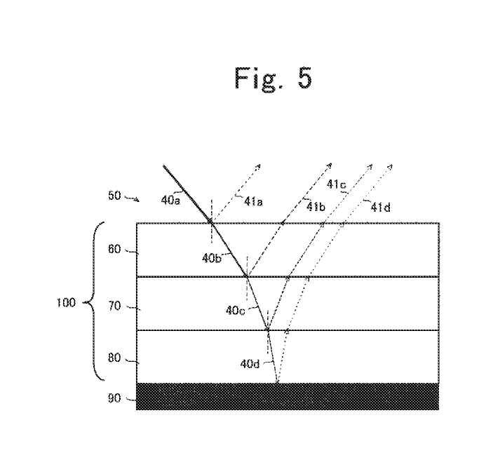

As the reason, the principle shown in FIG. 5 is assumed. As shown in FIG. 5, a laminate 100 is disposed on a black-colored layer 90, and has three transparent layers 80, 70, 60 disposed in order, respectively, from the base member side. The refractive indexes of the respective transparent layers satisfy a relationship of refractive index α<refractive index β<refractive index γ. An air layer 50 is positioned above the transparent layer 60.

Furthermore, a solid-line arrow shown in FIG. 5 represents incident light that is incident on the laminate 100. Dashed line arrows represent reflected light obtained by the incident light being reflected at boundaries between the transparent layers. Specifically, incident light 40a is light that is incident on the transparent layer 60 from the air layer 50. Incident light 40b is light that transmits through the transparent layer 60 and is incident on the transparent layer 70. Incident light 40c is light that transmits through the transparent layer 70 and is incident on the transparent layer 80. Incident light 40d is light that transmits through the transparent layer 80 and reaches the black-colored layer 90. Reflected light 41a is light obtained by the incident light 40a being reflected by the surface of the transparent layer 60. Reflected light 41b is light that is obtained by the incident light 40b being reflected at the boundary between the transparent layer 60 and the transparent layer 70, transmitting through the transparent layer 60, and reaching the air layer 50. Reflected light 41c is light that is obtained by the incident light 40c being reflected at the boundary between the transparent layer 70 and the transparent layer 80, transmitting through the transparent layer 70 and the transparent layer 60, and reaching the air layer 50. Reflected light 41d is light that is obtained by the incident light 40d being reflected by the surface of the black-colored layer 90, transmitting thorough the transparent layers 80, 70, and 60, and reaching the air layer 50.

As shown in FIG. 5, in the laminate 100 that includes the plurality of transparent layers 60, 70, 80 disposed on the black-colored layer 90, an amount of the incident light 40a that is incident on the laminate 100 is attenuated as the light transmits through the transparent layers 60, 70, 80 such that an amount of the incident light 40a>an amount of the incident light 40b>an amount of the incident light 40c>an amount of the incident light 40d is satisfied. Furthermore, the amounts of the reflected light 41a, 41b, 41c, 41d at boundaries between the transparent layers 60, 70, 80, are attenuated as the light transmits through the transparent layers, such that an amount of the reflected light 41a>an amount of the reflected light 41b>an amount of the reflected light 41c>an amount of the reflected light 41d, is satisfied. That is, the reflected light 41d which is obtained by reflecting light having reached the black-colored layer 90, and which reaches eyes of an observer, has the smallest light amount.

Furthermore, when the refractive indexes of the respective transparent layers are increased toward the base member in the order starting from a refractive index α of the outermost transparent layer, that is, when the relationship of the refractive index α<a refractive index β<a refractive index γ is satisfied, a traveling direction of the incident light that transmits through the transparent layers gradually approaches the vertical direction. Therefore, the incident light 40d that transmits through the transparent layer 80 is incident on the black-colored layer 90 at a small incident angle such as about 0 degrees to about 10 degrees.

When the incident angle of the incident light 40d is small, a reflection angle at which the incident light 40d is reflected by the black-colored layer 90 becomes small. That is, a direction in which the reflected light travels approaches the vertical direction. When the traveling direction of the reflected light of the incident light 40d approaches the vertical direction, the incident angle of the reflected light that is incident on the interfaces between the transparent layers becomes small, whereby total internal reflection is less likely to occur. Thus, the incident light 40d can reach the black-colored layer 90, and the reflected light 41d can reach the air layer 50. Therefore, an observer recognizes the black color of the black-colored layer 90.

Thus, when the laminate 100 is provided on the black-colored layer 90 as shown in FIG. 5, the reflected light 41d obtained by reflecting light having reached the black-colored layer 90, the reflected light 41a, 41b, 41c obtained by light being reflected at the interfaces between the transparent layers and attenuated stepwise, and any other reflected light that reaches the eyes of the observer are overlaid and reach the eyes of the observer. At this time, an amount of the reflected light 41d is attenuated so as to be smallest. Therefore, when the laminate 100 is disposed on the black-colored layer 90 as shown in FIG. 5, the attenuation of light due to the laminate 100 is assumed to allow an observer to perceive a jet-black color representing the profound “feeling of depth”.

The transparent layer includes a resin film layer formed from a transparent resin material. Examples of the resin material of the resin film layer include cellulose ester-based resins such as triacetylcellulose, polyester-based resins such as polyethylene terephthalate, cyclic hydrocarbon-based resins such as ethylene-norbornene copolymers, acrylic-based resins such as poly(methyl methacrylate) and poly(ethyl methacrylate), poly(meth)acrylimide-based resins, aromatic polycarbonate-based resins, polyolefin-based resins such as polypropylene, polyamide-based resins, polyarylate-based resins, polymer-type urethane acrylate-based resins, and polyimide-based resins.

The thickness of the resin film layer is not particularly limited. The resin film layer has any thickness as desired. The resin film layer preferably has a thickness of, for example, not less than 20 μm and not greater than 500 μm.

Furthermore, the transparent layer includes a clear coat layer formed by coating with transparent ink. The transparent ink contains a resin component and a solvent (water or organic solvent). Specifically, examples of the transparent ink include evaporation-drying type ink, ultraviolet curable ink, and two component curable ink.

A resin component contained in the evaporation-drying type ink is a thermoplastic resin. Examples of the resin component contained in the evaporation-drying type ink include acrylic resins, polystyrene, polyurethane, acrylic-styrene-based copolymers, acrylic-urethane-based copolymers, acrylic-epoxy-based copolymers, polyurethane acrylate, polyepoxy acrylate, polyester acrylate, polyether acrylate, polybutadiene acrylate, polyester, polyvinyl chloride, vinyl chloride-vinyl acetate copolymers, and epoxy resins. Regarding these resin components, a single type may be used, or a combination of two or more types may be used.

Examples of the solvent include hydrocarbon-based solvent such as hexane, heptane, octane, toluene, xylene, ethylbenzene, cyclohexane, and methylcyclohexane, ester-based solvent such as ethyl acetate, butyl acetate, 2-methoxyethyl acetate, and 2-ethoxyethyl acetate, alcohol-based solvent such as methanol, ethanol, propanol, butanol, ethylene glycol, and propylene glycol, ketone-based solvent such as acetone, methyl ethyl ketone, methyl isobutyl ketone, cyclohexanone, and isophorone, ether-based solvent such as diethyl ether, dioxane, and tetrahydrofuran, and water. Regarding the solvent, a single type may be used, or a combination of two or more types may be used.

The ultraviolet curable ink is ink that contains an ultraviolet curable resin, a photopolymerization initiator, and a solvent. Examples of the ultraviolet curable resin include urethane acrylate, epoxy acrylate, and polyester acrylate. Examples of the photopolymerization initiator include acetophenone and benzophenone. As the solvent, the same solvent as is contained in the evaporation-drying type ink is used.

The two component curable ink is ink that contains a thermosetting resin, a crosslinking agent, and a solvent. Examples of the thermosetting resin include acrylic resins, epoxy resins, unsaturated polyester resins, phenoxy resins, and urethane resins. Examples of the crosslinking agent include polyisocyanate and epoxy resins. As the solvent, the same solvent as is contained in the evaporation-drying type ink is used.

The thickness of the clear coat layer is not particularly limited. The clear coat layer has any thickness as desired. For example, when the clear coat layer is formed from the evaporation-drying type ink, the clear coat layer preferably has a thickness of not less than 1 μm and not greater than 10 μm. Furthermore, when the clear coat layer is formed from the ultraviolet curable ink, the clear coat layer preferably has a thickness of not less than 1 μm and not greater than 50 μm. Moreover, when the clear coat layer is formed from the two component curable ink, the clear coat layer preferably has a thickness of not less than 1 μm and not greater than 30 μm.

In the present embodiment, the laminate includes two resin film layers and one clear coat layer which are formed from different materials, respectively. However, the laminate may be any of a laminate that includes a plurality of resin film layers, a laminate that includes a plurality of clear coat layers, and a laminate obtained by the resin film layer and the clear coat layer being combined. For example, the laminate may be structured such that one or more clear coat layers are disposed on the base member side, and one or more resin film layers are layered on the clear coat layer. Furthermore, the laminate may be structured such that a plurality of clear coat layers are layered, or a plurality of resin film layers are layered. Alternatively, the laminate may be structured such that the clear coat layer is disposed between the resin film layers. In a case where a plurality of the resin film layers and the clear coat layers are layered, the resin film layers and the clear coat layers are preferably formed from different materials.

The transparent layers of the laminate have different refractive indexes, respectively. In the description herein, that the transparent layers have different refractive indexes, respectively, means that a difference between the refractive indexes of the transparent layers is not less than 0.01. Furthermore, the refractive indexes of the transparent layers are increased toward the base member in the order starting from the outermost transparent layer. The transparent layers have the refractive indexes which are in a range of preferably not less than 1.1 and preferably not greater than 2.0, and more preferably not less than 1.2 and more preferably not greater than 1.7. A difference between the refractive indexes of the transparent layers adjacent to each other is in a range of preferably not less than 0.01 and preferably not greater than 0.5, and more preferably not less than 0.03 and more preferably not greater than 0.2. A difference between the refractive indexes of the transparent layers adjacent to each other is in a range of still more preferably not less than 0.03 and still more preferably not greater than 0.16.

An incident angle at which light that transmits through the transparent layer disposed closest to the base member among the transparent layers of the laminate is incident on the black-colored layer provided at the base member is preferably not less than 0 degrees and preferably not greater than 20 degrees, and more preferably not less than 0 degrees and more preferably not greater than 10 degrees. When the transparent layers are layered as the laminate such that the incident angle is as described above, the decorative panel allows an observer to perceive the jet-black color representing more profound “feeling of depth”.

The decorative panel is produced by using a known method. In the present embodiment, the decorative panel is produced such that a resin film member formed from two or more kinds of resin film layers is initially formed integrally by extrusion molding, and screen printing is performed so as to layer the clear coat layer, the black-colored layer, and an adhesive layer in order, respectively, over the surface of the resin film member to form a film member. Thereafter, the film member is shaped, and insert molding is performed such that a resin material of the base member is injected into a mold having the shaped film member inserted in the mold, to produce the decorative panel of the present embodiment.

In another method, the resin film layers may be joined to each other by an adhesive. When the resin film layers are adhered to each other, the clear coat layer may be used as the adhesive. In this case, the surface of one of the resin films is coated with the above-described transparent ink, and the other of the resin films is layered over the transparent ink, to form the laminate having the resin film layer+the clear coat layer+the resin film layer. In any of the cases, the laminate on the black-colored layer provided at the base member is structured such that the refractive indexes of the transparent layers are increased toward the base member side (black-colored layer side) in the order starting from the outermost transparent layer.

A color ink layer may be provided between the black-colored layer and the base member. For example, the color ink layer is preferably formed from a colored transparent resin having a total light transmittance of approximately not less than 50% and approximately not greater than 80%. As the resin material, the same resin material as for the resin film layer as described above is used.

Hereinafter, the decorative panel of the present embodiment was evaluated for the jet-black color representing the profound “feeling of depth” by using the L* value defined in the L*a*b* color system specified in JIS Z 8729. In each experimental example, the L* value was measured three times by using a spectrophotometer CM-700d manufactured by KONICA MINOLTA, INC., and the average value was obtained. Evaluation of the decorative panel is considered such that the less the L* value is, the more profound the “feeling of depth” of the jet-black color is. In the following description, experimental example 1 and experimental example 2 and experimental examples 5 and 6 correspond to examples, and experimental examples 3 and 4 and experimental examples 7 and 8 correspond to comparative examples.

### Experimental Example 1

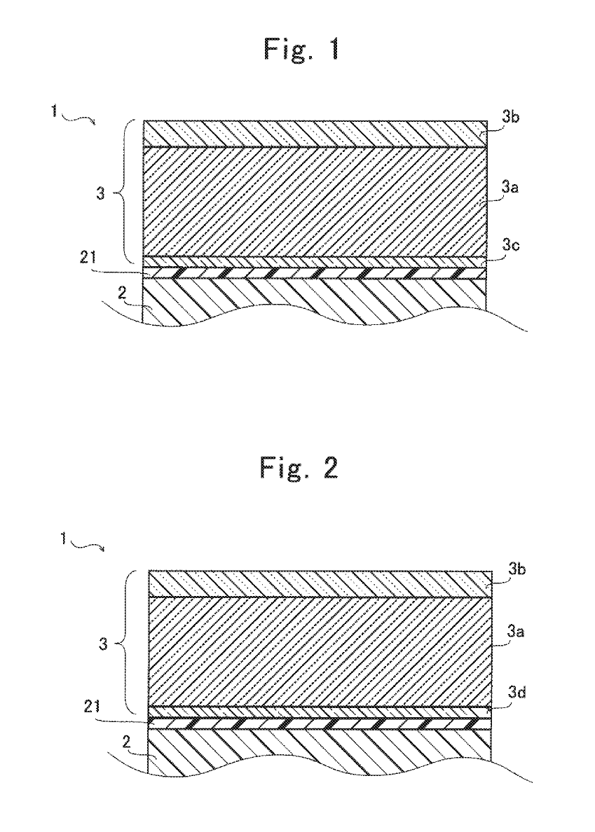

A decorative panel 1 of experimental example 1 had a laminate 3 formed from three transparent layers 3b, 3a, 3c as shown in FIG. 1. The decorative panel 1 of experimental example 1 was formed in the following manner. A resin film member formed from two transparent layers that were polycarbonate (PC) and acrylic resin (PMMA) layers, was firstly formed by extrusion molding. Thereafter, the PC surface of the resin film member was coated with ultraviolet curable (UV curable) transparent ink serving as the clear coat layer, black ink, and an adhesive in order, respectively, so as to be layered, by screen printing method, thereby forming a film member. Next, the film member was shaped into a predetermined shape, and the shaped film member was disposed in a mold such that the PMMA surface was on the mold surface side. The mold was filled with PC that was a resin material of the base member, that is, insert molding was performed, to integrally mold the base member and the film member. Thus, the decorative panel 1 of experimental example 1 was formed.

As shown in FIG. 1, in the formed decorative panel 1 of experimental example 1, the laminate 3, a black-colored layer 21, and an adhesive layer (not shown) are layered, in order, respectively, from the outer side, on a base member 2. In the laminate 3, the transparent layer 3b (PMMA) and the transparent layer 3a (PC) that are the resin film layers, and the transparent layer 3c (UV curable type) that is the clear coat layer, are layered in order, respectively, from the outer side toward the base member 2.

In the laminate 3 of experimental example 1, the transparent layer 3b (PMMA) had the thickness of 60 μm, the transparent layer 3a (PC) had the thickness of 240 μm, and the transparent layer 3c (UV curable type) had the thickness of 8 μm. Furthermore, in the laminate 3, the transparent layer 3b (PMMA) had the refractive index of 1.49, the transparent layer 3a (PC) had the refractive index of 1.58, and the transparent layer 3c (UV curable type) had the refractive index of 1.66. In the decorative panel 1 of experimental example 1, the refractive indexes of the transparent layers 3b, 3a, 3c were increased in order, respectively, from the outermost side toward the base member.

### Experimental Example 2

A decorative panel 1 of experimental example 2 had a laminate 3 formed from three transparent layers as shown in FIG. 2. The decorative panel 1 of experimental example 2 was different from the decorative panel 1 of experimental example 1 in that a material of the clear coat layer was changed from the UV curable transparent ink of the experimental example 1 to the evaporation-drying type transparent ink of experimental example 2, and the other components and the molding method were the same as in experimental example 1. That is, in the laminate 3 of the decorative panel 1 of experimental example 2, the transparent layer 3b (PMMA) and the transparent layer 3a (PC) that were the resin film layers, and a transparent layer 3d (evaporation-drying type) that was the clear coat layer were layered in order, respectively, from the outer side toward the base member 2.

In the laminate 3 of experimental example 2, the transparent layer 3b (PMMA) had the thickness of 60 μm, the transparent layer 3a (PC) had the thickness of 240 μm, and the transparent layer 3d (evaporation-drying type) had the thickness of 6 μm. Furthermore, in the laminate 3, the transparent layer 3b (PMMA) had the refractive index of 1.49, the transparent layer 3a (PC) had the refractive index of 1.58, and the transparent layer 3d (evaporation-drying type) had the refractive index of 1.68. In the decorative panel 1 of experimental example 2, the refractive indexes of the transparent layers 3b, 3a, 3d were increased in order, respectively, from the outermost side toward the base member.

### Experimental Example 3

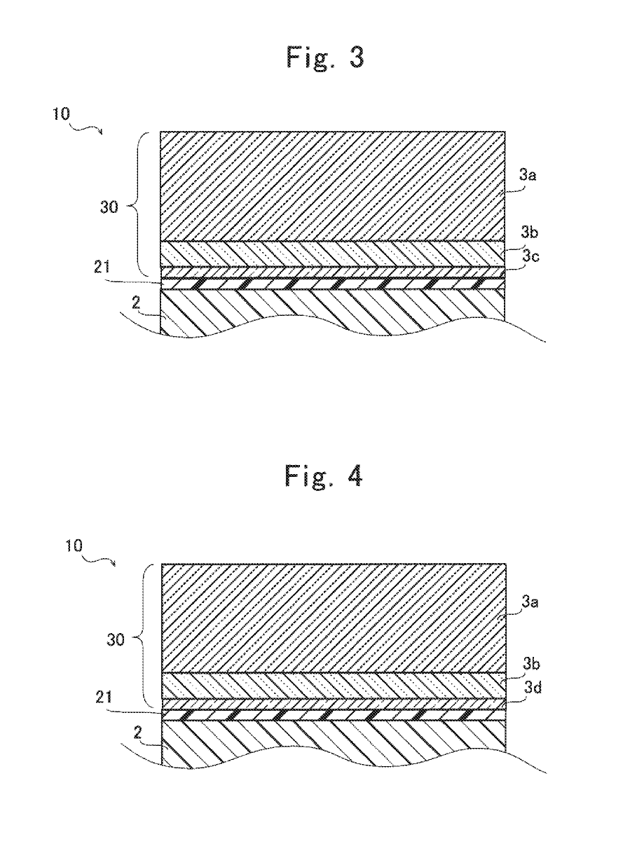

A decorative panel 10 of experimental example 3 had a laminate 30 formed from three transparent layers as shown in FIG. 3. The decorative panel 10 of experimental example 3 was different from experimental example 1 in that, in experimental example 3, transparent layers 3b, 3a, which were the resin film layers, were disposed (PMMA and PC were disposed) in order opposite to the order in the laminate 3 of experimental example 1, and the other components and the molding method were the same as in experimental example 1. That is, in the laminate 30 of experimental example 3, the transparent layer 3b (PMMA) was disposed on the transparent layer 3c (UV curable type) that was the clear coat layer on the base member 2 side, and the transparent layer 3a (PC) was disposed on the outermost side of the laminate 30.

In the laminate 30 of experimental example 3, the refractive indexes of the layers were not increased in order from the outermost side toward the base member.

### Experimental Example 4

A decorative panel 10 of experimental example 4 had a laminate 30 formed from three transparent layers as shown in FIG. 4. The decorative panel 10 of experimental example 4 was different from experimental example 2 in that the transparent layers 3b, 3a, which were the resin film layers, were disposed (PMMA and PC were disposed) in order opposite to the order in the laminate 3 of experimental example 2, and the other components and the molding method were the same as in experimental example 2. That is, in the laminate 30 of experimental example 4, the transparent layer 3b (PMMA) was disposed on the transparent layer 3d (evaporation-drying type) that was the clear coat layer on the base member 2 side, and the transparent layer 3a (PC) was disposed on the outermost side of the laminate 30.

In the laminate 30 of experimental example 4, the refractive indexes of the layers were not increased in order from the outermost side toward the base member.

### Experimental Example 5

A decorative panel of experimental example 5 was different from the decorative panel 1 of experimental example 1 in that, in the laminate 3, the transparent layer 3c (UV curable type) that was the clear coat layer had the thickness of 20 μm in experimental example 5, and the other components and the molding method were the same as in experimental example 1.

### Experimental Example 6

A decorative panel of experimental example 6 was different form the decorative panel 1 of experimental example 2 in that, in the laminate 3, the transparent layer 3d (evaporation-drying type) that was the clear coat layer had the thickness of 3 μm in experimental example 6, and the other components and the molding method were the same as in experimental example 2.

### Experimental Example 7

A decorative panel of experimental example 7 was different from the decorative panel 10 of experimental example 3 in that the transparent layer 3c (UV curable type) that was the clear coat layer had the thickness of 20 μm in experimental example 7, and the other components and the molding method were the same as in experimental example 3.

### Experimental Example 8

A decorative panel of experimental example 8 was different from the decorative panel 10 of experimental example 4 in that the transparent layer 3d (evaporation-drying type) that was the clear coat layer had the thickness of 3 μm in experimental example 8, and the other components and the molding method were the same as in experimental example 4.

Evaluation of the L* values in the above-described experimental examples is indicated below in Table 1 and Table 2.

TABLE 1

| | Experimental example | | | |
|---|---|---|---|---|
| | | | | Experimental |
| | | | Experimental | Example 4 |
| | Experimental | Experimental | Example 3 | (Com- |
| | Example 1 | Example 2 | (Comparative | parative |
| | (Example 1) | (Example 2) | Example 1) | Example 2) |
| Average | 25.19 | 25.04 | 28.73 | 28.57 |
| value | | | | |
| (L* value) | | | | |
| First | 25.18 | 25.03 | 28.73 | 28.59 |
| measurement | | | | |
| (L* value) | | | | |
| Second | 25.20 | 25.06 | 28.73 | 28.56 |
| measurement | | | | |
| (L* value) | | | | |
| Third | 25.18 | 25.04 | 28.73 | 28.57 |
| measurement | | | | |
| (L* value) | | | | |

TABLE 2

| | Experimental example | | | |
|---|---|---|---|---|
| | Experimental | Experimental | Experimental | Experimental |
| | Example 1 | Example 5 | Example 2 | Example 6 |
| | (Example 1) | (Example 3) | (Example 2) | (Example 4) |
| | Type | | | |
| | UV curable type | | Evaporation-drying type | |
| Film | 8 | 20 | 6 | 3 |
| thickness | | | | |
| (μm) | | | | |
| Average | 25.19 | 25.21 | 25.04 | 25.03 |
| value (L* | | | | |
| Value) | | | | |
| First | 25.18 | 25.21 | 25.03 | 25.05 |
| measurement | | | | |
| (L* value) | | | | |
| Second | 25.20 | 25.20 | 25.06 | 25.03 |
| measurement | | | | |
| (L* value) | | | | |
| Third | 25.18 | 25.21 | 25.04 | 25.02 |
| measurement | | | | |
| (L* value) | | | | |
| | Experimental example | | | |
| | | Experimental | Experimental | Experimental |
| | Experimental | Example 7 | Example 4 | Example 8 |
| | Example 3 | (Com- | (Com- | (Com- |
| | (Comparative | parative | parative | parative |
| | Example 1) | Example 3) | Example 2) | Example 4) |
| | Type | | | |
| | UV curable type | | Evaporation-drying type | |
| Film | 8 | 20 | 6 | 3 |
| thickness | | | | |
| (μm) | | | | |
| Average | 28.73 | 28.74 | 28.57 | 28.55 |
| value (L* | | | | |
| value) | | | | |
| First | 28.73 | 28.76 | 28.59 | 28.55 |
| measurement | | | | |
| (L* value) | | | | |
| Second | 28.73 | 28.74 | 28.56 | 28.55 |
| measurement | | | | |
| (L* value) | | | | |
| Third | 28.73 | 28.73 | 28.57 | 28.56 |
| measurement | | | | |
| (L* value) | | | | |

As indicated in Table 1, in experimental examples 1 and 2, the L* value is not greater than 26, whereas, in experimental examples 3 and 4, the L* value is not less than 28. In the laminate 3 of the decorative panel 1 of experimental examples 1 and 2, the refractive indexes of the transparent layers are increased in order starting from the outer side toward the base member. Meanwhile, in the laminate 30 of the decorative panel 10 of experimental examples 3 and 4, the refractive indexes of the transparent layers are not increased in order starting from the outer side toward the base member. Thus, when the refractive indexes of the transparent layers are increased in order starting from the outer side toward the base member as in the laminate 3 of the decorative panel 1 of experimental examples 1 and 2, the decorative panel having the black-colored layer is considered to allow an observer to perceive a jet-black color representing the profound “feeling of depth”.

Furthermore, as indicated in Table 1, in comparison between experimental example 1 having the UV curable type clear coat layer and experimental example 2 having the evaporation-drying type clear coat layer, the L* value in experimental example 2 is less than the L* value in experimental example 1. Thus, in experimental example 2 using the evaporation-drying type clear coat layer, a jet-black color representing more profound “feeling of depth” is considered to be advantageously expressed.

Table 2 indicates the evaluation of the L* values in the case of the thickness of the transparent layer which was the clear coat layer being changed. The thickness of the clear coat layer (UV curable type) in the laminate was greater in experimental example 5 than in experimental example 1. The thickness of the clear coat layer (evaporation-drying type) in the laminate was less in experimental example 6 than in experimental example 2. The thickness of the clear coat layer (UV curable type) in the laminate was greater in experimental example 7 than in experimental example 3. The thickness of the clear coat layer (evaporation-drying type) in the laminate was less in experimental example 8 than in experimental example 4. As indicated in Table 2, in any of the comparisons, the L* value was not significantly changed when the thickness of the transparent layer was changed. Thus, change of the thickness of the clear coat layer that is the transparent layer is proved to exert no influence on the L* value.

The decorative panel 1 of the present invention is recited as follows.

<1> A decorative panel 1 including: a base member 2; a black-colored layer 21 provided on the base member 2; and a laminate 3 provided on the black-colored layer 21, the laminate 3 having a plurality of transparent layers (3a, 3b, 3c, 3d) having different refractive indexes such that the plurality of transparent layers (3a, 3b, 3c, 3d) are layered, in which the refractive indexes of the transparent layers (3a, 3b, 3c, 3d) in the laminate 3 are increased in order toward the base member 2.
<2> The decorative panel 1 according to <1>, in which the transparent layers (3a, 3b, 3c, 3d) have the refractive indexes in a range of not less than 1.2 and not greater than 1.7.
<3> The decorative panel 1 according to <1> or <2>, in which a difference between the refractive indexes of the transparent layers (3a, 3b, 3c, 3d) adjacent to each other is in a range of not less than 0.01 and not greater than 0.5.
<4> The decorative panel 1 according to any one of <1> to <3>, in which the laminate 3 includes a clear coat layer (3c, 3d) formed by coating with transparent ink.
<5> The decorative panel 1 according to any one of <1> to <3>, in which the laminate 3 includes a film layer (3a, 3b) and a clear coat layer (3c, 3d) as the transparent layers, and the black-colored layer 21 and the film layer (3a, 3b) are adhered to each other by the clear coat layer (3c, 3d).
<6> The decorative panel 1 according to <4> or <5>, in which the transparent ink is of a UV curable type and/or an evaporation-drying type.

1. A decorative panel comprising:
a base member;
a black-colored layer provided on the base member; and
a laminate provided on the black-colored layer, the laminate having a plurality of transparent layers having different refractive indexes such that the plurality of transparent layers are layered, and
the refractive indexes of the transparent layers in the laminate are increased in order toward the base member.

2. The decorative panel according to claim 1, wherein the transparent layers have the refractive indexes in a range of not less than 1.2 and not greater than 1.7.

3. The decorative panel according to claim 1, wherein a difference between the refractive indexes of the transparent layers adjacent to each other is in a range of not less than 0.01 and not greater than 0.5.

4. The decorative panel according to claim 1, wherein the laminate includes a clear coat layer formed by coating with transparent ink.

5. The decorative panel according to claim 1, wherein
the laminate includes a film layer and a clear coat layer as the transparent layers, and
the black-colored layer and the film layer are adhered to each other by the clear coat layer.

6. The decorative panel according to claim 4, wherein the transparent ink is of a UV curable type and/or an evaporation-drying type.
